(19) United States
(12) Patent Application Publication
(10) Pub. No.: US 2019/0392511 A1
(43) Pub. Date: Dec. 26, 2019

(54) BID MATCHING FOR BLOCKCHAIN-BASED GOODS/ASSETS SYSTEMS AND METHODS

(71) Applicant: Rare Bits, Inc., San Francisco, CA (US)

(72) Inventors: Amitt Mahajan, San Francisco, CA (US); Payom Dousti, San Francisco, CA (US)

(21) Appl. No.: 16/444,572

(22) Filed: Jun. 18, 2019

Related U.S. Application Data
(60) Provisional application No. 62/688,337, filed on Jun. 21, 2018.
(60) Provisional application No. 62/689,748, filed on Jun. 25, 2018.

(51) Int. Cl. G06Q 30/08; G06Q 20/38; G06Q 20/36

(52) U.S. Cl. CPC G06Q 30/08; G06Q 20/389; G06Q 2220/00; G06Q 20/3825; G06Q 20/3678

(57) ABSTRACT

A bid matching for blockchain-based goods/assets system that allows users to participate in efficient and optimized auctions of blockchain-based assets/goods is disclosed. Instead of paying the current price for a blockchain-based item by signing and executing a transaction immediately, buyers pre-sign a crypto-transaction for a given future price of the item. The buyer sends the pre-signed crypto-transaction for future execution when the price of the blockchain-based good/asset matches (or falls below) a price that the buyer specified in the pre-signed transaction. Instead of executing bids on-chain, the bid matching for blockchain-based goods/assets system enables execution of an off-chain service that allows users to bid on one or more blockchain-based items with pre-signed transactions that are instantaneous and not dependent on network conditions. After an auction has ended, a winning bid is selected and executed automatically to consummate the purchase of the blockchain-based assets/goods.

### CROSS-REFERENCE TO RELATED APPLICATION

This application claims the benefit of the inventor's U.S. Provisional Patent Application No. 62/688,337, filed Jun. 21, 2018, entitled “OFF-CHAIN BIDDING WITH ON-CHAIN EXECUTION OF BLOCKCHAIN-BASED GOODS” (attorney docket number 125374-8003.US00), and U.S. Provisional Patent Application No. 62/689,748, filed Jun. 25, 2018, entitled “LIMIT ORDERS FOR BLOCKCHAIN-BASED GOODS/ASSETS” (attorney docket number 125374-8002.US00), both of which are incorporated by reference in their entireties.

### BACKGROUND AND OVERVIEW

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes can receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UXTO”) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity and when performing actions against tokens, ownership proof is established by providing a signature generated by the owner private key and validated against the public key listed as the owner of the token. A person can be uniquely identified, for example, using a combination of a user name, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) can be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection can be a cryptographic one-way hash of the digital tokens of the assets in the collection. The creation of an identity token for an asset in a blockchain establishes provenance of the asset, and the identity token can be used in transactions (e.g., buying, selling, insuring) of the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by its vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner and the transaction is evidence that the next owner is now the current owner.

To enable more complex transactions than bitcoin can support, some systems use “smart contracts.” A smart contract is computer code that implements transactions of a contract. The computer code can be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract can support the sale of an asset. The inputs to a smart contract to sell a car can be the identity tokens of the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code can retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, it requires large amounts of computer resources to support such redundant execution of the computer code.

The term “contract” has been used to describe the computer code of a contract under the UXTO model of bitcoin and the computer code of the “smart contracts” model of the Ethereum platform. The “contracts” under these models are, however, different. In the UXTO model, the distributed ledger is a set of immutable rows keyed by (hash: output index) values. The “hash” is a hash of the transaction that generated the output represented by the row, and the “output index” identifies which one of the possibly many outputs of the transaction the row represents. A UXTO contract is deterministic and performs no processing other than validating the inputs to the transaction. In the “smart contract” model, the computer code of the smart contract is an instantiation of the computer code that is maintained by every node that stores the block chain. A “smart contract” can perform virtually any type of processing such as receiving messages, sending messages, accessing external databases, and so on.

### BRIEF DESCRIPTION OF THE DRAWINGS

FIG. 1 is a block diagram showing some of the components typically incorporated in at least some of the computer systems and other devices on which the bid matching for blockchain-based goods/assets system operates.

FIG. 2 illustrates an example of a communications environment in which some embodiments of the bid matching for blockchain-based goods/assets system can be utilized.

FIG. 3 is a flow diagram showing a process performed by the bid matching for blockchain-based goods/assets system in some embodiments for purchasing blockchain-based goods in an auction setting.

FIG. 4 is a display diagram illustrating an example user interface for signing a transaction.

FIG. 5 is a display diagram illustrating an example user interface for publishing a signed transaction.

FIG. 6 is a system diagram illustrating an example of a computing environment in which the bid matching for blockchain-based goods/assets system operates in some embodiments.

FIGS. 7A-7E are display diagrams illustrating an example user interface for listing an item for auction on behalf of a buyer.

FIGS. 8A-8C are display diagrams illustrating an example user interface for placing a bid for an item listed for auction.

The drawings have not necessarily been drawn to scale. Similarly, some components and/or operations can be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Traditional processes for purchasing blockchain-based assets/goods (also called crypto-goods) (e.g., digital items, tickets, deeds, etc.) using crypto currency are convoluted and complicated for a typical end-user. These blockchain-based assets/goods, their owners, and their pricing data are stored on a blockchain and can be interacted with using, for example, a smart contract. The smart contract allows listing of goods, purchasing of listed goods, and the transfer of goods. All of these transactions occur “on-chain” and are denominated in a currency (such as, crypto-currency, fiat currency, token(s), etc.). On-chain transactions require a user to use their private key to sign a transaction. This allows funds to be withdrawn from their wallet (e.g., an electronic wallet) and sent to another user or to a smart contract. It usually costs the user a fee to execute a transaction on-chain and results in increased overhead in terms of execution time and cost.

Using traditional processes, blockchain-based assets/goods can be bought in multiple ways that reduce the number of transactions occurring on-chain. The most common approach is to have a fixed duration and decreasing price auction (Dutch auction). Decreasing price auctions require the seller to guess what price the market will pay. Traditional processes require precise timing on the part of the buyer to buy the item as the price hits the amount they are willing to pay. For example, when a buyer visits a website to purchase blockchain-based goods/assets, they see a price for a given blockchain-based good/asset. If the buyer wishes to purchase that good/asset at a lower price, he/she is unable to do so at that time. Instead, the buyer must wait (and continuously monitor the price of the good/asset) until a future date/time when the price decreases to a desirable price for that buyer. As a result, using traditional processes, sellers typically do not receive the best price for their goods and buyers end up not purchasing the listed assets/goods because the price is not what they are willing to pay. Traditional processes are further inefficient because they require the buyer to continuously track the price of the good/asset by visiting the website where it is listed for sale. Buyers who are unable to do so and track the price closely enough to purchase the good/asset at a desirable price lose out on opportunities to purchase a desired good/asset. For example, buyers who walk away from the website because the current price is not desirable are unable to execute an order for the good/asset at a future more desirable price. Further, since traditional processes require that all auction activity occur “on-chain,” they are slow to execute and are highly dependent on network conditions. These traits make it undesirable for traditional processes to run different types of auctions, such as a more efficient type of on-chain real-time highest-bid auction (English auction) for blockchain-based assets/goods (that are much better for price discovery and marketplace liquidity).

Accordingly, the inventors have conceived and reduced to practice a software and/or hardware system for bid matching for blockchain-based goods/assets that allows users to participate in efficient and optimized auctions of blockchain-based assets/goods. Instead of paying the current price for a blockchain-based good/asset by signing and executing a transaction immediately, buyers can pre-sign a crypto-transaction (for example, using their private key) for a given future price of the blockchain-based good/asset. The buyer can then send the pre-signed crypto-transaction to a third-party service (and/or the party hosting the sale of the good/asset) for future execution when the price of the blockchain-based good/asset matches (or falls below) a price that the buyer specified in the pre-signed transaction. Further, instead of executing bids on-chain, the bid matching for blockchain-based goods/assets system enables execution of an off-chain service that allows users to bid on one or more blockchain-based assets/goods with pre-signed transactions that are instantaneous and not dependent on network conditions (for example, they do not cost any network gas fees). After an auction has ended, the winning bid can be executed automatically to consummate the purchase of the blockchain-based assets/goods.

In the following description, for the purposes of explanation, numerous specific details are set forth in order to provide a thorough understanding of embodiments of the present technology. It will be apparent, however, to one skilled in the art that embodiments of the present technology can be practiced without some of these specific details. While, for convenience, embodiments of the present technology are described with reference to passive privacy breach notifications, embodiments of the present technology are equally applicable creating additional notifications in response to various triggering events.

The techniques introduced here can be embodied as special-purpose hardware (e.g., circuitry), as programmable circuitry appropriately programmed with software and/or firmware, or as a combination of special-purpose and programmable circuitry. Hence, embodiments can include a machine-readable medium having stored thereon instructions which can be used to program a computer (or other electronic devices) to perform a process. The machine-readable medium can include, but is not limited to, floppy diskettes, optical disks, compact disc read-only memories (CDROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in several embodiments,” “in some embodiments,” “according to several embodiments,” “in the embodiments shown,” “in other embodiments,” and the like generally mean the particular feature, structure, or characteristic following the phrase is included in at least one implementation of the present technology and can be included in more than one implementation. In addition, such phrases do not necessarily refer to the same embodiments or different embodiments.

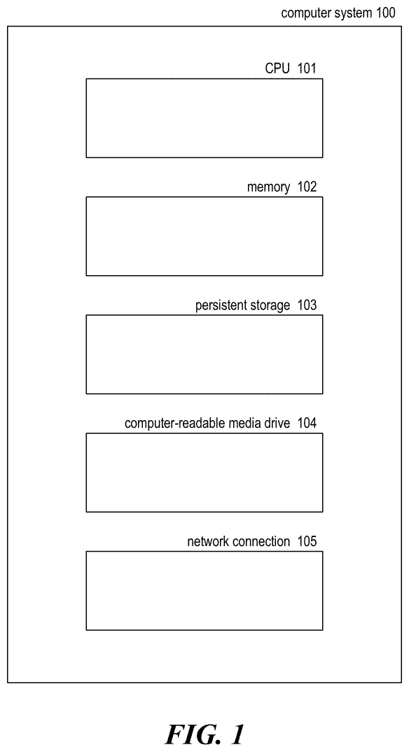

FIG. 1 is a block diagram showing some of the components typically incorporated in at least some of the computer systems and other devices on which the bid matching for blockchain-based goods/assets system operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the bid matching for blockchain-based goods/assets system and associated data, an operating system including a kernel, and device drivers; a persistent storage device 103, such as a hard drive or flash drive for persistently storing programs and data; a computer-readable media drive 104 that are tangible storage means that do not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. The computing systems can include a secure cryptoprocessor as part of a central processing unit for generating and securely storing keys and for encrypting and decrypting data using the keys. While computer systems configured as described above are typically used to support the operation of the bid matching for blockchain-based goods/assets system, those skilled in the art will appreciate that the bid matching for blockchain-based goods/assets system can be implemented using devices of various types and configurations and having various components.

The bid matching for blockchain-based goods/assets system can be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules can be combined or distributed as desired in various examples. Aspects of the bid matching for blockchain-based goods/assets system can be implemented in hardware using, for example, an application-specific integrated circuit (ASIC) or field programmable gate array (“FPGA”).

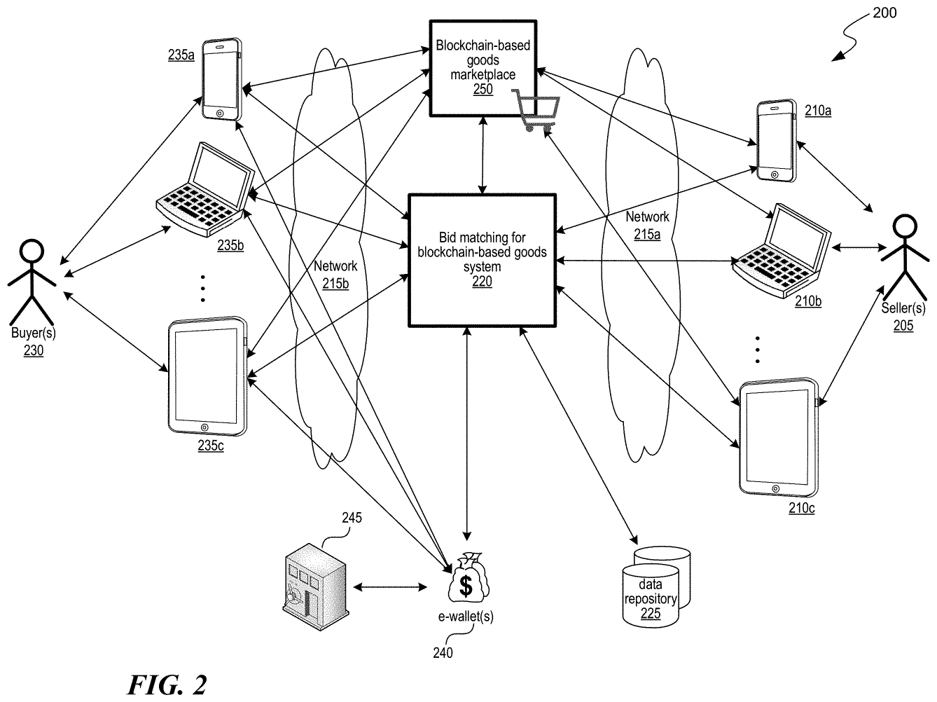

FIG. 2 illustrates an example of a communications environment 200 in which some embodiments of the bid matching for blockchain-based goods/assets system can be utilized. In various embodiments, environment 200 comprises a bid matching for blockchain-based goods/assets system 220. Seller(s) 205 can use various electronic devices (e.g., mobile device 210a, laptop/PC 210b, tablet 210c, and so on) to list one or more goods/assets for sale on the blockchain. A blockchain-based goods/assets that is listed for sale can be associated with one or more rights, such as: a right to own the blockchain-based item by the buyer, a right to trade the blockchain-based item by the buyer with another user, a right to transfer ownership of the blockchain-based item to another user, a right to grant one or more rights to another user in the blockchain-based item, a right to license one or more rights to another user in the blockchain-based item, etc.

In several embodiments, seller(s) 205 can list the blockchain goods/assets for sale directly at a blockchain-based goods marketplace 250, a blockchain smart contract platform based on, for example, Ethereum, and so on via a communications network 215a, such as a Local Area Network (“LAN”), Wide Area Network (“WAN”), the Internet, and the like. Seller(s) 205 can also communicate with a bid matching for blockchain-based goods/assets 220 via communications network 215a (e.g., using web services) regarding goods/assets listed for sale in an auction setting. In several embodiments, the blockchain-based goods marketplace 250 is integrated with the bid matching for blockchain-based goods/assets system 220 (e.g., as an integrated e-commerce auction platform for blockchain-based goods/assets).

Buyer(s) 230 can use various electronic devices (e.g., mobile device 235a, laptop/PC 235b, tablet 235c, and so on) to browse, search for, and purchase one or more goods/assets listed for sale on the blockchain. For example, buyer(s) 230 can access an integrated e-commerce platform for blockchain-based goods/assets via communications network 215b (e.g., using web services). Buyer(s) 230 and/or the bid matching for blockchain-based goods/assets system 220 can also communicate with one or more blockchain wallets 240 (for example, using a cryptocurrency account), which can be in communication with a cryptocurrency provider 245, to provide payment for the purchased blockchain-based goods/assets. The bid matching for blockchain-based goods/assets system 220 can also communicate with one or more data storage repositories 225 to store and/or access information about one or more goods/assets listed for sale (e.g., good/asset identifier, description, selling price, seller, quantity, auction price, minimum bid price, reserve price, bid price increment value(s), auction structure, shipping information, etc.), seller(s) (e.g., seller identifier, name, address, contact information, ratings, etc.), buyer(s) (e.g., buyer identifier, name, address, contact information, ratings, cryptocurrency address(es), etc.), and so on.

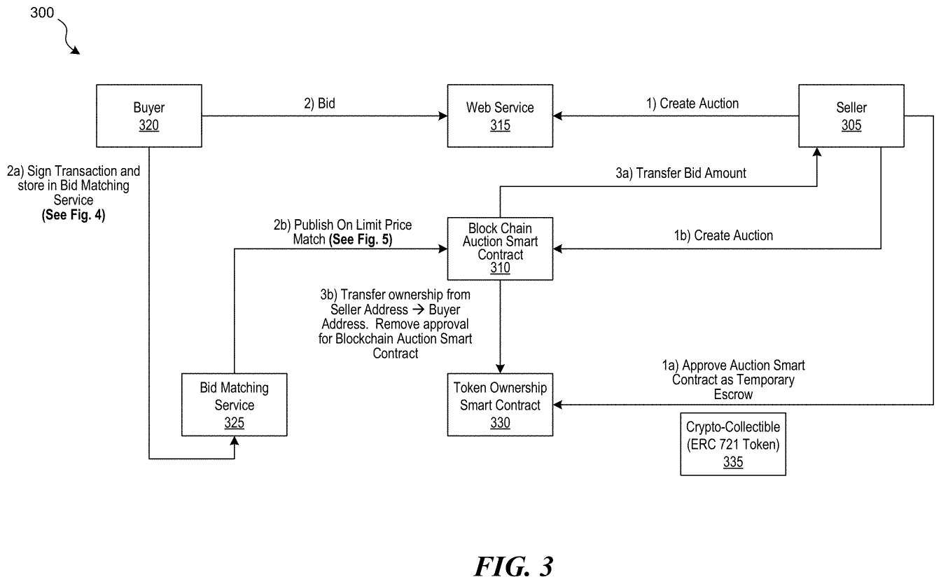

FIG. 3 is a flow diagram showing a process 300 performed by the bid matching for blockchain-based goods/assets system in some embodiments for conducting an auction of blockchain-based goods (using, for example, an English style auction (highest-bid auction), a Dutch style auction, etc.). The bid matching for blockchain-based goods/assets system enables such auctions by pre-signing a purchase transaction for blockchain-based goods/assets at a given price (or better) to be executed at a future date/time (for example, by a third-party system) to complete the transaction at a desirable price. A seller 305 can list a good/asset (e.g., a blockchain-based good/asset) for an auction sale with a blockchain smart contract platform 310 (e.g., the blockchain-based goods marketplace 250 in FIG. 2) via, for example, web services 315, by providing details about the good/asset (e.g., identifier, name, description, image, price, auction price, auction type, etc.) (acts 1 and 1(b)). In several embodiments, the seller 305 can be presented with an option to set a price curve (for example, bonded price curver) rather than a static price. For example, the seller 305 can set a price which decays in a linear fashion from a starting price to and ending price over a defined period of time.

In several embodiments, as part of listing the blockchain-based good/asset for an auction sale, seller 305 puts the blockchain-based good/asset up for an auction sale by escrowing it in a smart contract owned by the blockchain smart contract platform 310, setting a duration, setting a reserve price, setting a desired execution price (also known as “ask”), and so on (act 1(a)). The escrow for the blockchain-based good/asset can be approved as a temporary escrow via, for example, a token ownership smart contract platform 330. The token ownership smart contract platform 330 can be maintained by a third party that is different from the entity that owns/manages the blockchain smart contract platform 310. In several embodiments, the auction escrow can be approved by invoking a smart contract function that creates an escrow account for some amount of crypto currency and/or crypto-collectible 335. For example, a crypto-collectible that follows ERC721 (a non-fungible token standard implemented for Ethereum) can be used during act 1(a). (The crypto-collectible, e.g. ERC721 token, can be the crypto good being bought or sold, and thus is solely or primarily the good being exchanged in the transaction, where the medium of exchange is ether or another crypto currency.)

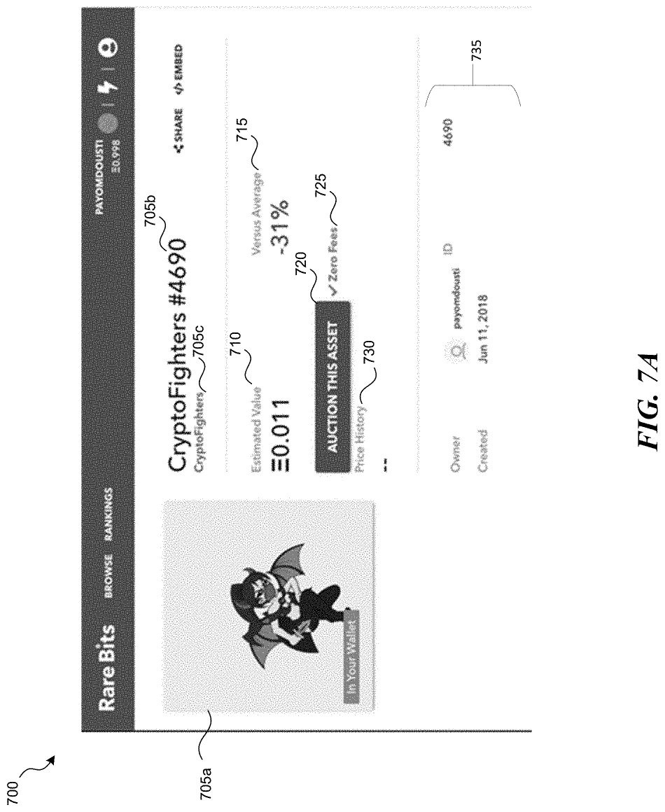

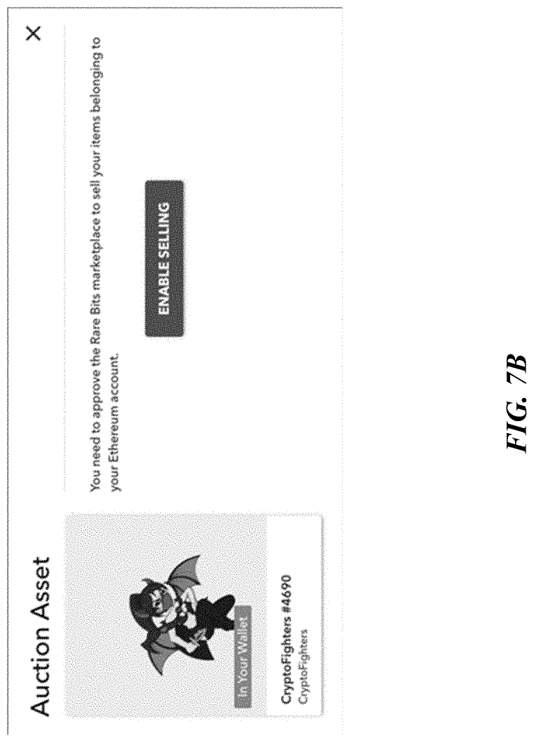

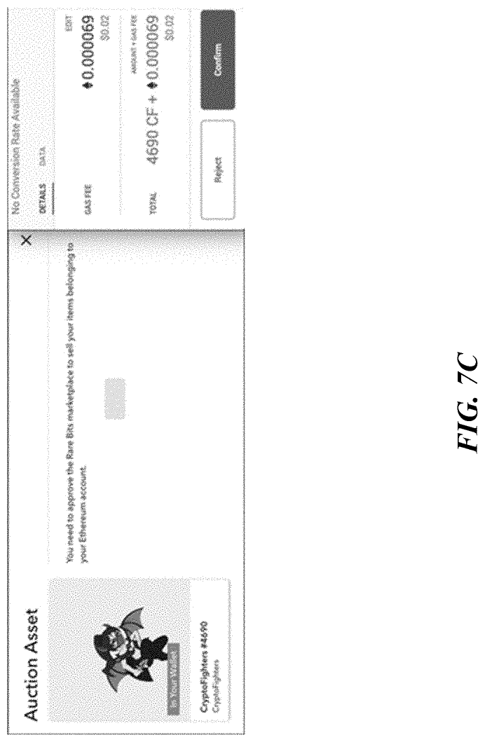

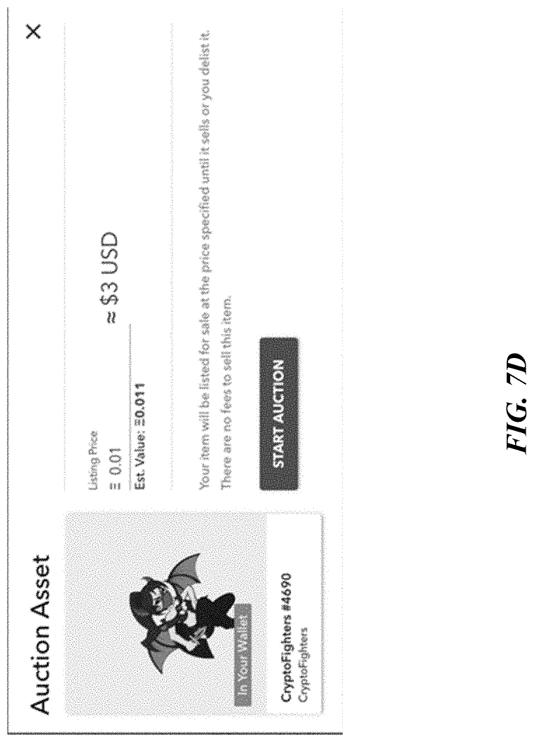

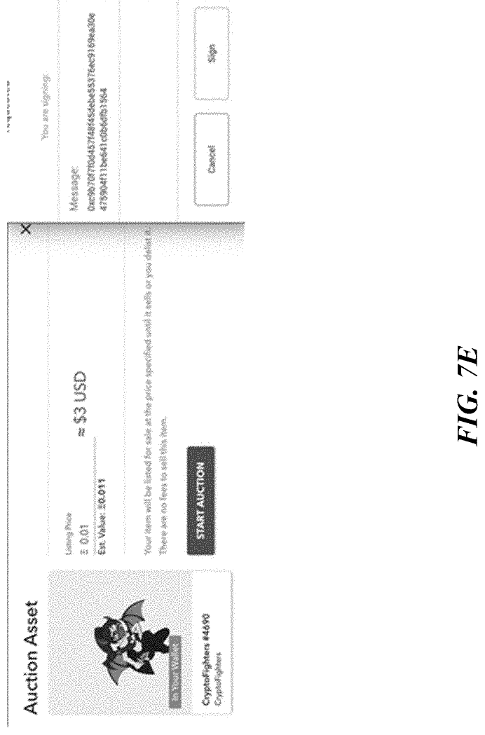

FIGS. 7A-7E are display diagrams illustrating an example user interface for listing an item for auction on behalf of a buyer. FIG. 7A is a display diagram illustrating an example user interface 700 where a buyer can view and/or provide the following details for an item (blockchain based good/asset) to be listed for sale at an auction: information about the good/asset (for example, image 705a, item name 705b, item category 705c, and so on), estimated value of the item 710 (in cryptocurrency, fiat currency, points, tokens, etc.), average price of one or more similar items 715, fees associated with the auction 725, price history 730, and ownership information 735. A user (for example, the buyer or a party on behalf of the buyer) can select to list the item for auction by selecting control 720. Upon selecting control 720 to ‘auction this asset’ the user can be prompted to approve the auction and enable selling (FIG. 7B). For example, once the user selects a wallet from which where the item to be auctioned resides, the user is prompted to sign a transaction that approves the auction smart contract as temporary escrow (FIG. 7C). The user is then prompted to enter a desired execution price for the auction (also known as the ‘ask) and a type of the auction (for example, English type (increasing), Dutch type (decreasing), and so on) (FIG. 7D). The user is then prompted to sign the transaction which will approve the transfer of the asset on the blockchain if the ask is fulfilled (FIG. 7E).

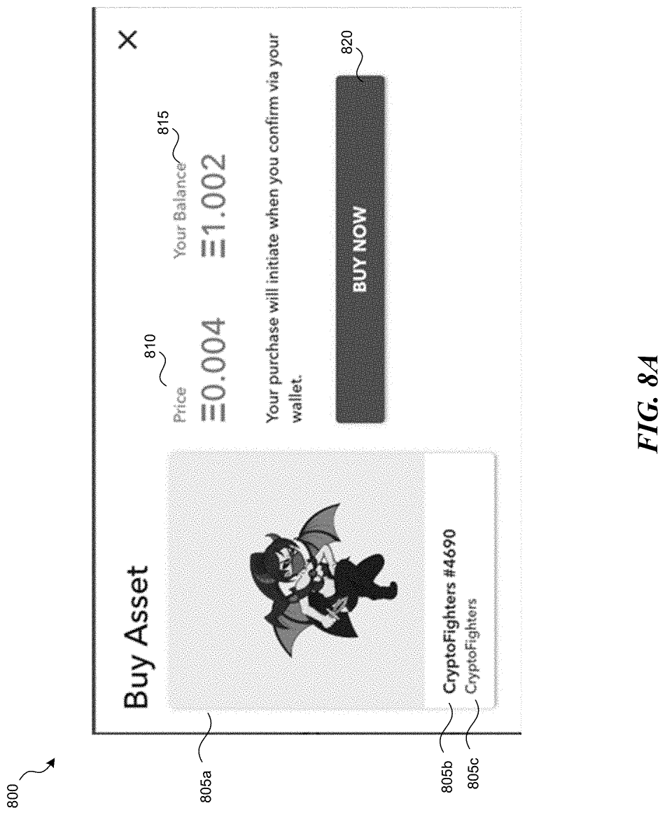

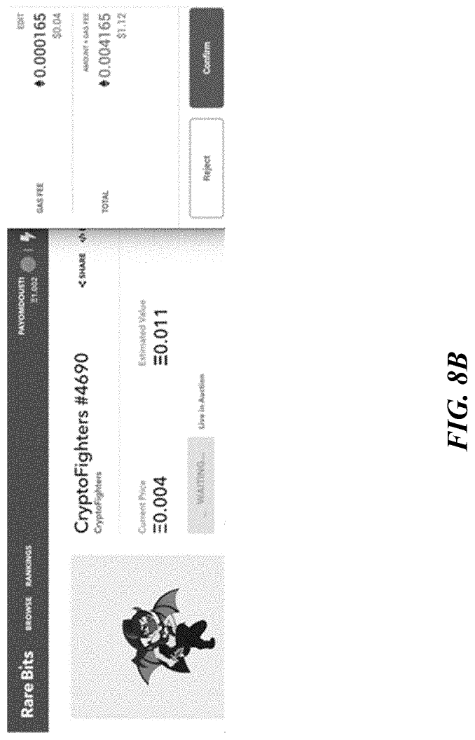

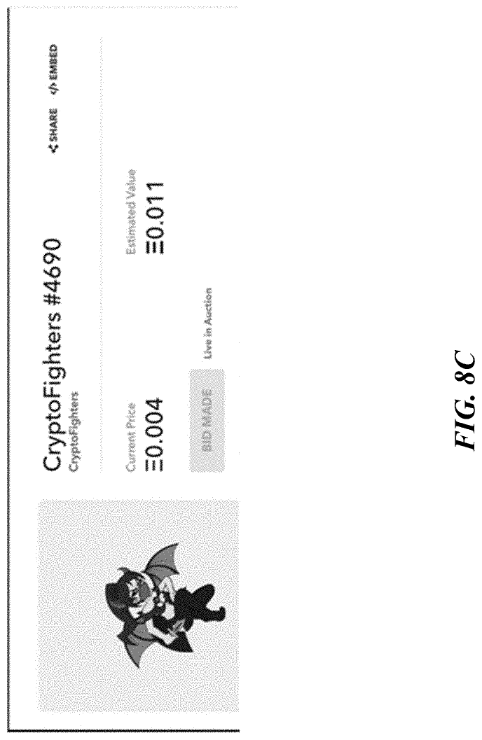

Once the blockchain-based good/asset is listed for an auction sale, the web service 315 can publish the item (and its auction details) at a user interface so that potential buyers can view the item and bid on it. One or more buyers 320 can bid on one or more blockchain-based goods/assets listed for an auction sale. In several embodiments, buyer 320 submits bids for a listed blockchain-based good/asset in the form of a decreasing price transaction or an increasing price transaction. FIGS. 8A-8C are display diagrams illustrating an example user interface for placing a bid for an item listed for auction. For example, as shown in FIG. 8A, a buyer interested in buying a right in a listed blockchain-based good/asset is presented with a user interface 800 that he/she can use to place a bid. The buyer can view information about the listed blockchain-based good/asset (for example, image 805a, item name 805b, item category 805c, and so on), current auction price 810, starting auction price, buyer's wallet balance 815, and so on. Once the buyer selects control 820 to place a bid on a selected blockchain-based good/asset, the buyer can be prompted to sign a transaction for storage in the bid matching service. For example, as shown in FIG. 8B, for a frictionless user experience, the user interface defaults to the ask price which will result in immediate matching and therefore execution of the exchange.

In several embodiments, to submit bids for a blockchain-based good/asset listed for an auction sale, buyer 320 can sign the transaction that is then stored in a bid matching service 325 (act 2(a)). However, instead of paying the current price for blockchain-based good/asset by signing and executing a transaction immediately, buyer 320 can pre-sign (pre-authorize) a crypto-transaction (for example, using their private key) for a desired (future) price of the good/asset. The desired (future) price of the good/asset can be a firm number (represented in fiat currency, cryptocurrency, tokens, points, etc.), a range (for example, a range spanning a minimum price and a maximum price), a portion of the current auction price (for example, a percentage of the auction price), and so on.

The transaction can be signed using the private key (for example, private key of the buyer, private key of an authorized user, etc.) using the user interface provided by an electronic software wallet (for example, Metamask) or a hardware wallet (for example, Ledger, Trezor, etc.). In several embodiments, when the buyer has delegated signing authority to another party (for example, the private key is held in a custodial service), the transaction needs to be pre-signed. In several embodiments, based on one or more factors, such as when the buyer is a “trusted” buyer, the transaction amount is below a threshold value (low-risk transactions), any other such scenarios, process 300 may not require that the transaction is pre-signed. In several embodiments, instead of allowing users to pre-sign bid transactions without withdrawing funds from their account (for example, buyer's e-wallet), process 300 can require that a buyer 320 deposit funds into an escrow account before bidding begins. This makes it impossible for the buyer to have insufficient funds when bidding ends. The escrow account can be a smart contract, or an account owned by the buyer.

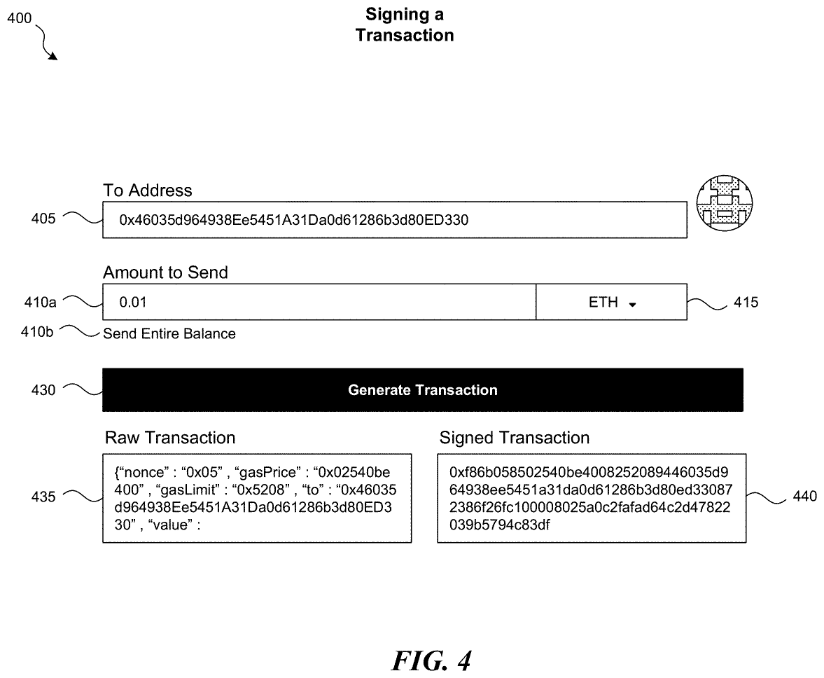

FIG. 4 is a display diagram illustrating an example user interface 400 for signing a transaction. Buyer 320 (and/or any other authorized entity authorized by the buyer) can enter (and/or view) information at user interface 400. In several embodiments, when buyer 320 has authorized a purchase amount up to a certain limit (for example, a preconfigured amount), the buyer can be able to provide a “blank cheque” with a limit transaction that allows the bid matching service to fill in the eventual purchase price. Buyer 320 can provide the following information to the bid matching service 325 during signing of the transaction: recipient address 405 (address of the smart contract that is handling the auction execution), amount to send (or the desired future price of the good/asset) 410a, amount currency 415 (for example, BTC Bitcoin, ETH Ethereum, XRP Ripple, BCH Bitcoin Cash, fiat currency, and so on), option to send the entire balance 410b (or send it in increments), and so on. In several embodiments, when the buyer specifies the currency as a fiat currency (instead of a crypto-currency) to purchase the good, the buyer can deposit the fiat currency (e.g., US Dollars) with a third-party service, which would then withdraw the funds from the buyer's account when the transaction is executed. In this case, the USD can be converted to a crypto-currency first.

In several embodiments, if the wallet is a “multi-signature” wallet, then multiple parties sign the transaction before executing it. Upon selection of the “Generate Transaction” option 430, user interface 400 can display both the raw transaction data 435 and the signed transaction data 440. Raw transaction data can be an encoded command (for example, an encoded Ethereum command). The signed transaction data can be generated using a nonce, the amount of ether, the raw transaction data, etc. to generate a signed transaction. In several embodiments, bid matching service 325 can require the user to pre-deposit the funds to execute the transaction (at the desired future price) in an escrow account. Or the bid matching service can withdraw the funds from the buyer's wallet at the time the order execution transaction notification is received. The latter case can result in order executions failing if the user has insufficient funds, at which point the system would need to go to the next order, and so on. Once the buyer signs the bid transaction, the transaction is published to the blockchain (FIG. 8C).

Returning to FIG. 3, bid matching service 325 maintains a log of all bid transactions submitted by one or more buyers for a listed blockchain-based good/asset and/or matches each received bid (including bid price) against the listed blockchain-based good/asset. Bid matching service 325 can prioritize certain bids over others (e.g., based on buyer's past behavior (e.g., does buyer pay on time, amount of funds in buyer's account/escrow, etc.), credit rating of buyer, buyer priority, buyer membership level, a type of the auction, the starting auction price, etc.). For example, buyers with high priority (or with a premium membership) could get priority versus bids submitted by buyers with lower priority (or regular membership). In several embodiments, buyers can submit bids in the form of decreasing (or increasing) price pre-signed transactions. Bid matching service 325 can continuously (for example, at a certain frequency) monitor the current price of the blockchain-based good/asset listed for auction (e.g., in a decreasing price auction). Bid matching service 325 can further monitor the bids received for that item as well as the order in which the bids are received. This is important to ensure fairness of bid transaction execution as many of these blockchain-based goods/assets have limited quantities or can be in high demand by many simultaneous buyers.

For example, bid matching service 325 can sort the received bid transactions by price (e.g., decreasing) and time (e.g., increasing) to determine bid transaction execution order. So, for a good that is currently $7 and decreasing in price, bid matching service 325 can execute a first transaction at $5 sent at 12:00 am before a second transaction for $5 sent at 12:01am. But bid matching service 325 can execute a transaction for $6 sent at 1:00 am before the other orders at $5 as the price will cross the $6 threshold first.

Upon conclusion of the bidding process, bid matching service 325 selects a winning bid. Bidding process can conclude when one or more criteria are met, such as limit price match (a matching bid transaction is found for the current price of the good/asset), time period elapse, reserve price match, total number of bids match, minimum number of bids match, overall liquidity reserve match, and so on. In several embodiments, the seller can also just choose which bid to accept. Bid matching service 325 can select a winning bid based on one or more parameters, such as highest bid amount, timestamp associated with the bid transaction, credit rating of buyer, past performance of buyer, buyer review(s), location of buyer, location of seller, shipping cost, and so on. For example, bid matching service 325 selects the highest and earliest bid as the winning bid. After selecting the winning bid, bid matching service 325 can execute the winning bid to automatically consummate the purchase of the listed blockchain-based good/asset. For example, bid matching service 325 publishes a signed transaction corresponding to the winning bid with the blockchain smart contract platform 310 when the bidding process concludes (for example, when a reserve price match is met or when the auction expires) (act 2(b)). The bid matching for blockchain-based goods/assets system can utilize various trading strategies to select a winning bid, such as, but not limited to, limit, market, stop market, stop limit, opportunistic, time-weighted average price (TWAP), float, instant, and so on.

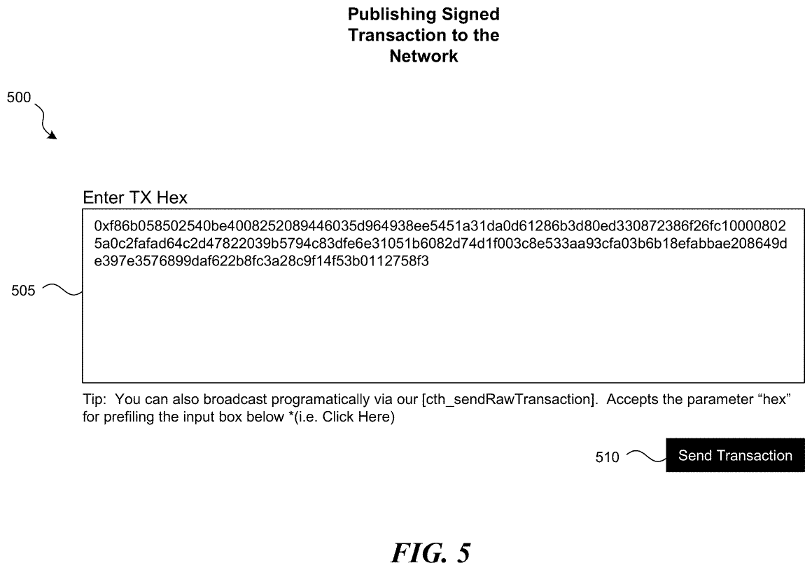

FIG. 5 is a display diagram illustrating an example user interface 500 for publishing a signed transaction. In several embodiments, user interface 500 displays an encrypted value of the signed transaction (for example, a hex value of the transaction) 505. Upon selection of the “Send Transaction” option 510, the bid matching service 325 publishes/broadcasts the signed transaction to the blockchain smart contract platform 310 (so that it can be broadcast to the blockchain and miners can begin mining the transaction to add it to the blockchain).

In several embodiments, instead of automatically executing the winning bid, the buyer can choose to “accept” a bid, whereby the buyer simply accepts an offer to purchase their item versus having it automatically be accepted. This ensures that a third-party system cannot purposefully execute bids at the reserve price to “front-run” other bids. Returning to FIG. 3, upon receiving a signed transaction, the blockchain smart contract platform 310 transfers the winning bid amount (for example, specified at field 410a in FIG. 4) from the buyer's account to the seller 305 via, for example, a smart contract (act 3(a)). The blockchain smart contract platform 310 can further transfer ownership of the bid-upon blockchain-based good/asset from the seller's address to the buyer's address and update the token ownership smart contract platform 330 (act 3(b)). For example, the blockchain smart contract platform 310 updates the token ownership smart contract platform 330 to remove the temporary escrow created at act 1(a) with the token ownership smart contract platform 330.

In this manner, the bid matching for blockchain-based goods/assets system combines the benefits of on-chain decentralized exchanges with a much cheaper off-chain model for bidding. The bid matching for blockchain-based goods/assets system presents several advantages over traditional systems by enabling better price discovery between sellers and buyers. For instance, by participating in the bid matching for blockchain-based goods/assets system, sellers are more likely to find a buyer, at some price, for their blockchain-based goods/assets. Further, sellers can retain control of their blockchain-based goods/assets because these goods/assets are directly transferred from the seller to the buyer. The decentralized ownership property enabled by the blockchain is maintained. Buyers participating in the bid matching for blockchain-based goods/assets system can have a more engaging auction format where they have more control over the price they pay for a blockchain-based good/asset and higher confidence that the price being paid is the most competitive and optimum price. Buyers are able to set their price and walk away from the system and still have an order executed in a pre-consented way. Additionally, the bid matching for blockchain-based goods/assets system can optimize matches between buyers and sellers off-chain by using a local database, thus making bidding free (or available at a minimized cost) for buyers. The bid matching for blockchain-based goods/assets system can increases marketplace liquidity and create a more engaging auction experience than traditional systems and processes.

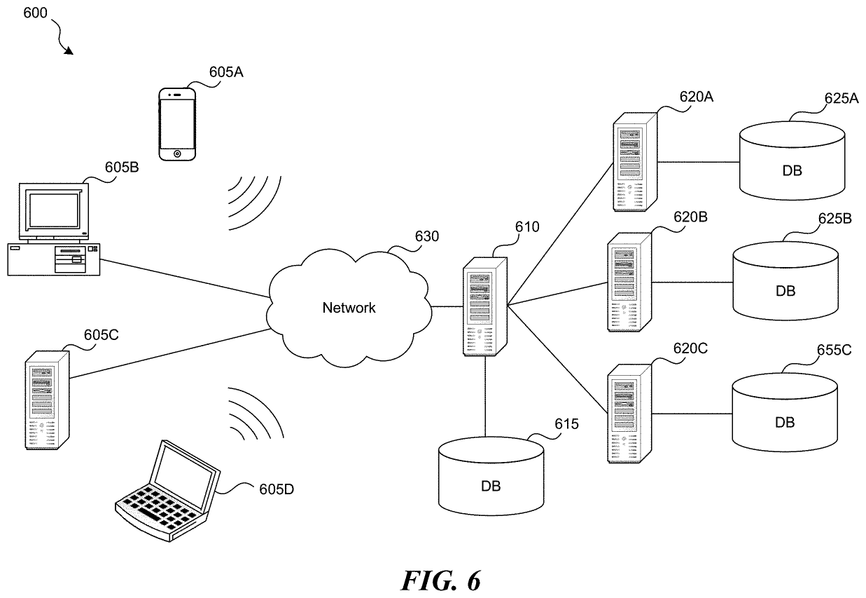

FIG. 6 is a system diagram illustrating an example of a computing environment in which the bid matching for blockchain-based goods/assets system operates in some embodiments. In some implementations, environment 600 includes one or more client computing devices 605A-D, examples of which can include computer system 100. Client computing devices 605 operate in a networked environment using logical connections 610 through network 630 to one or more remote computers, such as a server computing device.

In some implementations, server 610 is an edge server which receives client requests and coordinates fulfillment of those requests through other servers, such as servers 620A-C. In some implementations, server computing devices 610 and 620 comprise computing systems, such as computer system 100. Though each server computing device 610 and 620 is displayed logically as a single server, server computing devices can each be a distributed computing environment encompassing multiple computing devices located at the same or at geographically disparate physical locations. In some implementations, each server 620 corresponds to a group of servers.

Client computing devices 605 and server computing devices 610 and 620 can each act as a server or client to other server/client devices. In some implementations, servers (610, 620A-C) connect to a corresponding database (615, 625A-C). As discussed above, each server 620 can correspond to a group of servers, and each of these servers can share a database or can have its own database. Databases 615 and 625 warehouse (e.g., store) information such as user data (e.g., user identifiers, user profiles, etc.), good/asset data (e.g., identifier, name, description, price, quantity, auction amount, etc.), cryptocurrency addresses, fiat-to-cryptocurrency and cryptocurrency-to-fiat exchange rates, etc. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. In some implementations, network 630 is the Internet or some other public or private network. Client computing devices 605 are connected to network 630 through a network interface, such as by wired or wireless communication. While the connections between server 610 and servers 620 are shown as separate connections, these connections can be any kind of local, wide area, wired, or wireless network, including network 630 or a separate public or private network.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include not only additional elements to those implementations noted above, but also can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A bid matching for blockchain-based goods/assets system, the system comprising at least one non-transitory computer-readable medium having instructions stored thereon, which when executed by one or more processors of the system cause the system to:
receive, on behalf of a seller, a request to list a blockchain-based item for sale,
wherein the received request to list the blockchain-based item for sale comprises identifying information about the blockchain-based item and a starting auction price of the blockchain-based item;
list the blockchain-based item for an auction sale with a blockchain smart contract platform;
receive, on behalf of potential buyers, bids to purchase the blockchain-based item,
wherein each bid comprises a signed crypto-transaction for a desired purchase price of the blockchain-based item;
execute a bidding process for the auction sale until a bid conclusion criteria is met,
wherein the bidding process comprises:
monitoring a current auction price of the blockchain-based item;
matching each received bid against the current auction price of the blockchain-based item; and
evaluating whether the bid conclusion criteria is met; and
when the bid conclusion criteria is met, select a winning bid among the received bids to purchase the blockchain-based item.

2. The system of claim 1, wherein the winning bid is selected based on one or more of: highest bid amount, timestamp associated with the bids, credit ratings of the potential buyers, reviews of the potential buyers, locations of the buyers, location of the seller, or shipping costs.

3. The system of claim 1, wherein the bid conclusion criteria comprises one or more of: limit price match, time period elapse, reserve price match, total numbers of bid match, minimum number of bids match, or liquidity reserve match.

4. The system of claim 1, wherein the received bids are matched against the listed blockchain-based item in an order that is based on one or more of: behaviors of the potential buyers, credit ratings of the potential buyers, priority of the potential buyers, membership levels of the potential buyers, a type of the auction sale, the starting auction price, the desired purchase prices, or timestamp of the received bids.

5. The system of claim 1, wherein at least one of the received bids is a decreasing price pre-signed transaction.

6. The system of claim 1, wherein the crypto-transaction is signed without withdrawing funds from a crypto-wallet of the potential buyer, and wherein the buyer deposits a threshold amount of funds in an escrow account before the buyer can submit the bid to purchase the blockchain-based item.

7. The system of claim 1, wherein listing the blockchain-based item for the auction sale comprises:
escrowing the blockchain-based item in a smart contract; and
associating the auction sale with at least one of: a duration of the auction sale or a reserve price of the blockchain-based item, and wherein the escrow of the blockchain-based item in the smart contract is approved by a temporary escrow via a token ownership smart contract platform.

8. The system of claim 1, wherein listing the blockchain-based item for the auction sale comprises:
escrowing the blockchain-based item in a smart contract; and
associating the auction sale with at least one of: a duration of the auction sale or a reserve price of the blockchain-based item.

9. The system of claim 1, wherein the request to list a blockchain-based item for sale further comprises a type of the auction sale, and wherein the type of the auction sale is a decreasing price auction.

10. The system of claim 1, wherein the request to list a blockchain-based item for sale further comprises: image, retail price, minimum auction price, maximum auction price, auction type, or any combination thereof.

11. The system of claim 1, wherein the starting auction price of the blockchain-based item is represented in terms of a fiat currency.

12. The system of claim 1, wherein the starting auction price of the blockchain-based item is represented in terms of a crypto currency.

13. The system of claim 1, wherein the blockchain-based item is associated with at least one right, and wherein the at least one right in the blockchain-based item comprises:
a right to own the blockchain-based item by the buyer,
a right to trade the blockchain-based item by the buyer with another user,
a right to transfer ownership of the blockchain-based item to another user,
a right to grant one or more rights to another user in the blockchain-based item,
a right to license one or more rights to another user in the blockchain-based item,
or any combination thereof.

14. The system of claim 1, wherein the instructions when executed by the one or more processors of the system further cause the system to:
execute a smart contract corresponding to the winning bid to complete a sale of the blockchain-based item from the seller to a buyer associated with the winning bid.

15. The system of claim 1, wherein the instructions when executed by the one or more processors of the system further cause the system to:
receive a confirmation from a buyer associated with the winning bid; and
upon receiving the confirmation, execute a smart contract corresponding the winning bid to complete a sale of the blockchain-based item from the seller to the buyer associated with the winning bid.

16. A computer-implemented method for performing bid matching for blockchain-based items, the method comprising:
receiving, on behalf of a seller, a request to list a blockchain-based item for sale,
wherein the received request to list the blockchain-based item for sale comprises identifying information about the blockchain-based item and a starting auction price of the blockchain-based item;
listing the blockchain-based item for an auction sale with a blockchain smart contract platform;
receiving, on behalf of potential buyers, bids to purchase the blockchain-based item,
wherein each bid comprises a signed crypto-transaction for a desired purchase price of the blockchain-based item;
executing a bidding process for the auction sale until a bid conclusion criteria is met,
wherein the bidding process comprises:
monitor a current auction price of the blockchain-based item;
match each received bid against the current auction price of the blockchain-based item; and
evaluate whether the bid conclusion criteria is met; and
when the bid conclusion criteria is met, selecting a winning bid among the received bids to purchase the blockchain-based item.

17. The method of claim 16, further comprising:
executing a smart contract corresponding to the winning bid to complete a sale of the blockchain-based item from the seller to a buyer associated with the winning bid.

18. The method of claim 16, wherein the winning bid is selected based on one or more of: highest bid amount, timestamp associated with the bids, credit ratings of the potential buyers, reviews of the potential buyers, locations of the buyers, location of the seller, or shipping costs.

19. The method of claim 16, wherein the received bids are matched against the listed blockchain-based item in an order that is based on one or more of: behaviors of the potential buyers, credit ratings of the potential buyers, priority of the potential buyers, membership levels of the potential buyers, a type of the auction sale, the starting auction price, the desired purchase prices, or timestamp of the received bids.

20. At least one non-transitory, computer-readable medium carrying instructions, which when executed by at least one data processor, performs operations for transferring rights involving blockchain-based items using fiat currency, the operations comprising:
receiving, on behalf of a seller, a request to list a blockchain-based item for sale,
wherein the received request to list the blockchain-based item for sale comprises identifying information about the blockchain-based item and a starting auction price of the blockchain-based item;
listing the blockchain-based item for an auction sale with a blockchain smart contract platform;
receiving, on behalf of potential buyers, bids to purchase the blockchain-based item,
wherein each bid comprises a signed crypto-transaction for a desired purchase price of the blockchain-based item;
executing a bidding process for the auction sale until a bid conclusion criteria is met,
wherein the bidding process comprises:
monitor a current auction price of the blockchain-based item;
match each received bid against the current auction price of the blockchain-based item; and
evaluate whether the bid conclusion criteria is met;
when the bid conclusion criteria is met, selecting a winning bid among the received bids to purchase the blockchain-based item; and
executing a smart contract corresponding to the winning bid to complete a sale of the blockchain-based item from the seller to a buyer associated with the winning bid.
